(19) United States
(12) Patent Application Publication
(10) Pub. No.: US 2012/0086142 A1
(43) Pub. Date: Apr. 12, 2012

(54) IMPRINT SYSTEM, IMPRINT METHOD, AND NON-TRANSITORY COMPUTER STORAGE MEDIUM

(75) Inventors: Shoichi Terada, Kumamoto (JP); Yoshio Kimura, Kumamoto (JP); Takahiro Kitano, Kumamoto (JP)

(73) Assignee: Tokyo Electron Limited, Tokyo (JP)

(21) Appl. No.: 13/378,079

(22) PCT Filed: Jun. 21, 2010
(86) PCT No.: PCT/JP2010/060464

§ 371 Date: Dec. 14, 2011

(30) Foreign Application Priority Data
Jun. 24, 2009 (JP) 2009-149935

(51) Int. Cl. B29C 59/02; B29C 59/00; B28B 17/00

(52) U.S. Cl. 264/39; 425/225; 425/167

(57) ABSTRACT

The present invention is a system including: an imprint unit transferring a transfer pattern to a coating film on a substrate using a template to form a predetermined pattern in the coating film; a treatment station connected to the imprint unit and performing a predetermined treatment on the template; a template carry-in/out station connected to the treatment station, capable of keeping templates, and carrying the template in/out from/to the treatment station; a carry line provided through the imprint unit and carrying the template between the imprint unit and the treatment station; and a substrate carry-in/out station connected to the imprint unit, capable of keeping substrates, and carrying the substrate in/out from/to the imprint unit.

### TECHNICAL FIELD

The present invention relates to an imprint system forming a predetermined pattern in a coating film on a substrate, an imprint method using the imprint system, and a non-transitory computer storage medium.

### BACKGROUND ART

In a manufacturing process of a semiconductor device, for example, photolithography processing is performed, for example, on a semiconductor wafer (hereinafter, referred to as a “wafer”) to form a predetermined resist pattern on the wafer.

When forming the above-described resist pattern, miniaturization of the resist pattern is required in order for higher integration of the semiconductor device. Generally, the limit of miniaturization in the photolithography processing is about the wavelength of light used in exposure processing. Therefore, conventionally, the wavelength of light for use in the exposure processing has been increasingly reduced. However, there are technical and cost limits in reducing the wavelength of an exposure light source, and it is now difficult to form a fine resist pattern at a level of, for example, several nanometers only by the method of increasingly reducing the wavelength of light.

Hence, it is recently proposed to form a fine resist pattern on the wafer using a so-called imprint method instead of performing photolithography processing on the wafer. This method is to bring a template (referred also to as a mold or a die) having a fine pattern on its front surface into press contact with the resist surface formed on the wafer and then peel off the template to thereby directly transfer the pattern to the resist surface (Patent Document 1).

### PRIOR ART DOCUMENT

### Patent Document

[Patent Document 1] Japanese Laid-open Patent Publication No. 2009-43998

### DISCLOSURE OF THE INVENTION

### Problems to be Solved by the Invention

Incidentally, when the above-described imprint method is repeatedly performed, namely, when resist patterns are formed on a plurality of wafers using one template, the transfer of pattern cannot be correctly performed any longer from a certain point in time. This is caused by deterioration of a release agent, having liquid repellency to a resist, whose film is typically formed on the front surface of the template. Therefore, it is necessary to periodically replace the template.

Further, when different resist patterns are formed on a plurality of wafers, the template needs to be replaced for each resist pattern.

However, efficient replacement of the template is not considered at all in the conventional imprint method. Therefore, for example, when a defect such as deterioration or the like occurs in the template, defective resist patterns will be continuously formed on wafers. Further, for example, when different resist patterns are formed on a plurality of wafers, the templates corresponding to the different resist patterns could not be efficiently replaced in the conventional imprint method. Accordingly, it is actually difficult to successively form predetermined resist patterns on a plurality of wafers, thus failing to cope with mass production of semiconductor devices.

The present invention is made in consideration of the above points, and it is an object to efficiently replace a template and successively form predetermined patterns on a plurality of substrates.

### Means for Solving the Problems

To achieve the above object, the present invention is an imprint system forming a predetermined pattern in a coating film on a substrate, the imprint system including: an imprint unit transferring a transfer pattern to the coating film on the substrate using a template having the transfer pattern formed on a front surface thereof to form a predetermined pattern in the coating film; a treatment station connected to the imprint unit and performing a predetermined treatment on the template; a template carry-in/out station connected to the treatment station, capable of keeping a plurality of the templates, and carrying the template in/out from/to the treatment station; a carry line provided through the imprint unit and carrying the template between the imprint unit and the treatment station; and a substrate carry-in/out station connected to the imprint unit, capable of keeping a plurality of the substrates, and carrying the substrate in/out from/to the imprint unit. Further, the imprint unit includes a substrate holding part holding the substrate, a template holding part holding a template carried by the carry line, and a moving mechanism raising and lowering the template holding part, and the substrate holding part and the template holding part are arranged such that the substrate held by the substrate holding part and the template held by the template holding part face each other.

Since the imprint system of the present invention has the substrate carry-in/out station and the template carry-in/out station and templates can be successively carried by the carry line between the treatment station and the imprint unit, it is possible to form a predetermined pattern on a substrate using a template and then successively replace the template with other templates in the imprint unit. This ensures that before the template deteriorates or even when different patterns are formed on a plurality of substrates, the template in the imprint unit can be successively and efficiently replaced. Accordingly, predetermined patterns can be successively formed on a plurality of substrates.

The present invention according to another aspect is an imprint method using an imprint system, the imprint system including: an imprint unit transferring a transfer pattern to a coating film formed on a substrate using a template having the transfer pattern formed on a front surface thereof to form a predetermined pattern in the coating film; a treatment station connected to the imprint unit and performing a predetermined treatment on the template; a template carry-in/out station connected to the treatment station, capable of keeping a plurality of the templates, and carrying the template in/out from/to the treatment station side; a carry line provided throughout the imprint unit and the treatment station, and carrying the template between the treatment station and the imprint unit; and a substrate carry-in/out station connected to the imprint unit, capable of keeping a plurality of the substrates, and carrying the substrate in/out from/to the imprint unit side, the imprint method including the steps of: forming a predetermined pattern on a substrate using one of the templates in the imprint unit; and then carrying the one template out of the imprint unit and carrying another of the templates into the imprint unit and replacing the template in the imprint unit.

The present invention in still another aspect is a non-transitory computer-readable storage medium storing a program running on a computer of a control unit controlling an imprint system to cause the imprint system to execute the above-described imprint method.

### Effect of the Invention

According to the present invention, it is possible to efficiently replace a template and successively form predetermined patterns on a plurality of substrates.

### BRIEF DESCRIPTION OF THE DRAWINGS

FIG. 1A plan view illustrating the outline of the configuration of an imprint system according to this embodiment.

FIG. 2 A side view illustrating the outline of the configuration of the imprint system according to this embodiment.

FIG. 3 A side view illustrating the outline of the configuration of the imprint system according to this embodiment.

FIG. 4 A perspective view of a template.

FIG. 5 A longitudinal sectional view illustrating the outline of the configuration of an imprint unit.

FIG. 6 A transverse sectional view illustrating the outline of the configuration of the imprint unit.

FIG. 7 A side view illustrating the outline of the configuration of a transition unit.

FIG. 8 A longitudinal sectional view illustrating the outline of the configurations of treatment units on a release agent treatment line.

FIG. 9 A longitudinal sectional view illustrating the outline of the configuration of a post-cleaning unit.

FIG. 10 A transverse sectional view illustrating the outline of the configuration of a reversing unit.

FIG. 11 A longitudinal sectional view illustrating the outline of the configuration of the reversing unit.

FIG. 12 A flowchart illustrating steps of imprint processing.

FIG. 13 An explanatory view schematically illustrating the states of a template and a wafer in respective steps of the imprint processing, FIG. 13(a) illustrating the appearance that the front surface of the template is cleaned, FIG. 13(b) illustrating the appearance that a release agent is applied on the front surface of the template, FIG. 13(c) illustrating the appearance that the release agent on the template is baked, FIG. 13(d) illustrating the appearance that a film of the release agent is formed on the template, FIG. 13(e) illustrating the appearance that a resist solution is applied on the template, FIG. 13(f) illustrating the appearance that photo polymerization of the resist film on the template takes place, FIG. 13(g) illustrating the appearance that a resist pattern is formed on the wafer, and FIG. 13(h) illustrating the appearance that a residual film on the wafer is removed.

FIG. 14 A plan view illustrating the outline of the configuration of an imprint system according to another embodiment.

FIG. 15 A plan view illustrating the outline of the configuration of an imprint system according to another embodiment.

FIG. 16 A plan view illustrating the outline of the configuration of an imprint system according to another embodiment.

FIG. 17 A longitudinal sectional view illustrating the outline of the configuration of an imprint unit according to another embodiment.

FIG. 18 A plan view illustrating the outline of the configuration of an imprint system according to another embodiment.

FIG. 19 A plan view illustrating the outline of the configuration of an imprint system according to another embodiment.

FIG. 20 A transverse sectional view illustrating the outline of the configuration of an imprint system according to another embodiment.

FIG. 21 A plan view illustrating the outline of the configuration of an imprint unit according to another embodiment.

FIG. 22 A plan view illustrating the outline of the configuration of an imprint system according to another embodiment.

FIG. 23 A plan view illustrating the outline of the configuration of an imprint system according to another embodiment.

FIG. 24 A longitudinal sectional view illustrating the outline of the configuration of a release agent coating unit according to another embodiment.

FIG. 25 An explanatory view schematically illustrating the states of a template in respective steps of a treatment of forming a film of a release agent on the template, FIG. 25(a) illustrating the appearance that the front surface of the template is cleaned, FIG. 25(b) illustrating the appearance that a vaporized release agent is deposited on the front surface of the template, and FIG. 25(c) illustrating the appearance that the release agent on the template is baked.

FIG. 26 A plan view of a holder.

FIG. 27 A longitudinal sectional view of the holder.

### BEST MODE FOR CARRYING OUT THE INVENTION

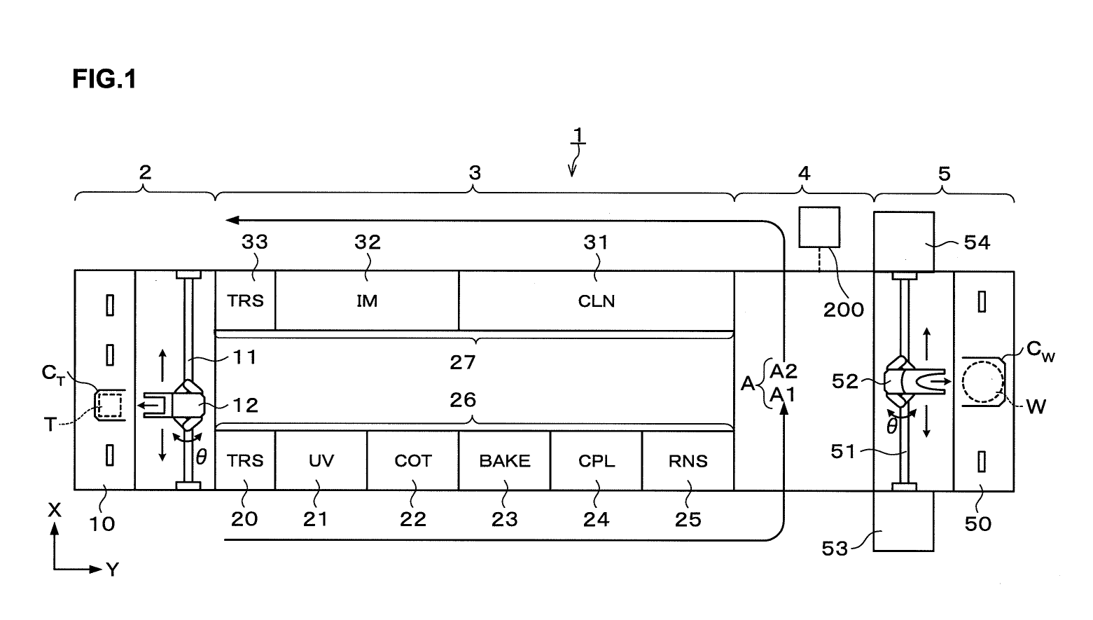

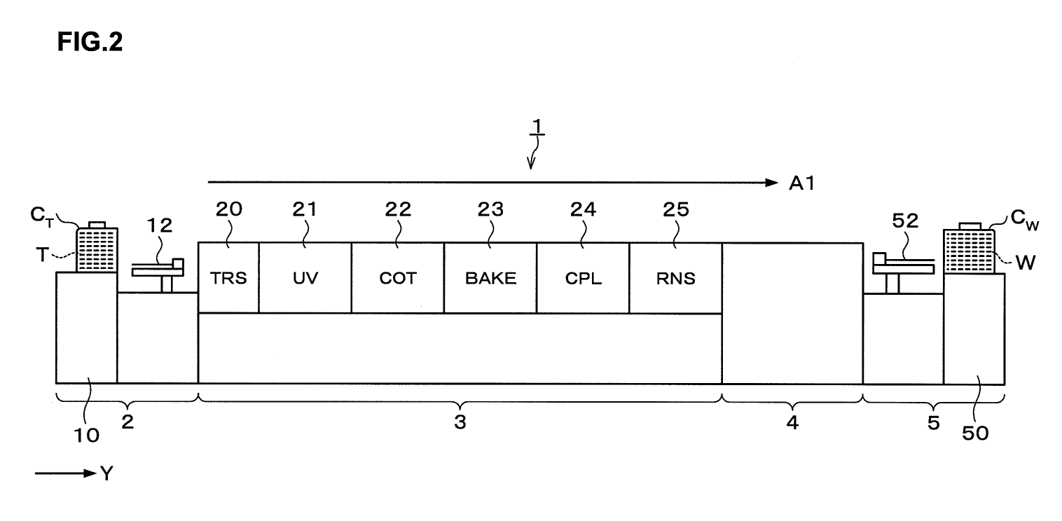

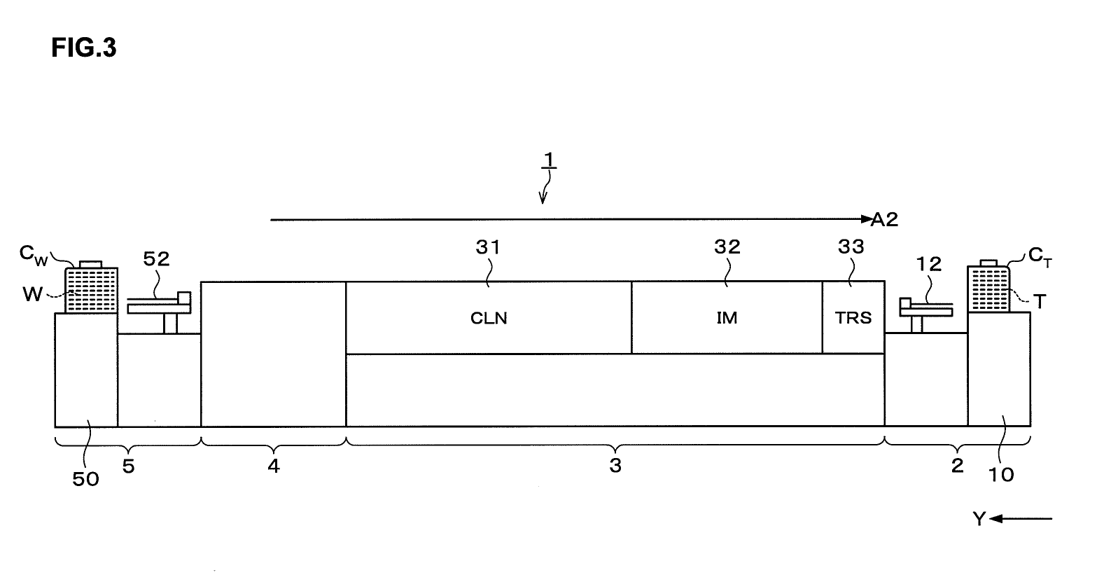

Hereinafter, an embodiment of the present invention will be described. FIG. 1 is a plan view illustrating the outline of the configuration of an imprint system 1 according to this embodiment. FIG. 2 and FIG. 3 are side views illustrating the outline of the configuration of the imprint system 1.

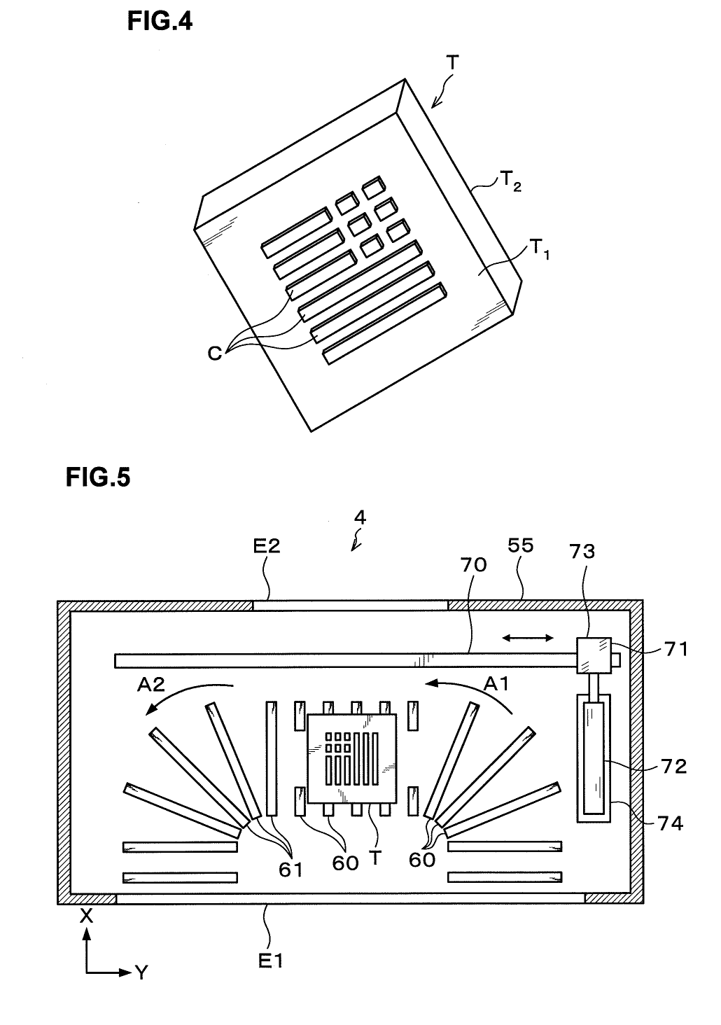

In the imprint system 1 of this embodiment, a template T which has a rectangular parallelepiped shape and a predetermined transfer pattern C formed on its front surface as illustrated in FIG. 4 is used. Hereinafter, the surface of the template T on which the transfer pattern C is formed is referred to as a front surface T₁ and the surface opposite the front surface T₁ is referred to as a rear surface T₂. Note that for the template T, a transparent material which can transmit light such as visible light, near ultraviolet light, ultraviolet light, for example, glass is used.

The imprint system 1 has, as illustrated in FIG. 1, the configuration in which a template carry-in/out station 2 for carrying a plurality of, for example, 5 templates T per cassette as a unit from/to the outside into/from the imprint system 1 and carrying the templates T into/out of a template cassette C_{T}, a treatment station 3 including a plurality of treatment units performing predetermined treatments on the template T, an imprint unit 4 for forming a resist pattern on a wafer W as a substrate using the template T, and a wafer carry-in/out station 5 as a substrate carry-in/out station for carrying a plurality of, for example, 25 wafers W per cassette as a unit from/to the outside into/from the imprint system 1 and carrying the wafers W into/out of a wafer cassette C_{W}, are integrally connected.

In the template carry-in/out station 2, a cassette mounting table 10 is provided. The cassette mounting table 10 is configured such that a plurality of template cassettes C_{T} can be mounted thereon in a line in an X-direction (a top and bottom direction in FIG. 1). In other words, the template carry-in/out station 2 is configured to be capable of keeping a plurality of templates T therein.

In the template carry-in/out station 2, a template carrying body 12 is provided which is movable on a carry path 11 extending in the X-direction. The template carrying body 12 is also movable in a vertical direction and around the vertical (in a O-direction), and thus can carry the template T to the imprint unit 4 side, namely, between the template cassette C_{T} and the treatment station 3.

In the treatment station 3 and the imprint unit 4, a carry line A for carrying the template T between the treatment station 3 and the imprint unit 4 is provided. The carry line A has, for example, a first carry line A1 for carrying the template T carried out of the template carry-in/out station 2 to the imprint unit and a second carry line A2 for carrying the template T carried from the imprint unit into the carry-in/out station 2. In these first carry line A1 and second carry line A2, a later-described plurality of carry rollers 60, 61 are arranged side by side so that the template T can be carried by roller carry (roller-conveyer method). The carry line A1 is arranged on the front side in the treatment station 3 (on an X-direction negative direction side in FIG. 1) and the carry line A2 is arranged on the rear side in the treatment station 3 (on an X-direction positive direction side in FIG. 1).

On the carry line A1 in the treatment station 3, a release agent forming section 26 is provided which forms a film of a release agent on the template T carried toward the imprint unit 4. In the release agent forming section 26, a transition unit 20 for passing the template T, a pre-cleaning unit 21 cleaning the front surface T₁ before a film of the release agent is formed on the template T, a release agent coating unit 22 applying a liquid release agent to the template T, a heating unit 23 performing heat treatment on the template T, a temperature regulation unit 24 regulating the temperature of the template T, and a rinse unit 25 rinsing the release agent on the template T away are linearly arranged in a line in order from the template carry-in/out station 2 side to the imprint unit 4 side as illustrated in FIG. 2.

On the carry line A2 in the treatment station 3, a template cleaning section 27 is provided which removes the release agent on the template T carried from the imprint unit 4 to clean the front surface of the template T. In the template cleaning section 27, a post-cleaning unit 31 cleaning the front surface T₁ of a used template T, an inspection unit 32 inspecting the cleaned front surface T₁ of the template T, and a transition unit 33 are linearly arranged in a line in order from the imprint unit 4 side to the template carry-in/out station 2 side. Note that the post-cleaning unit 31 may further clean the rear surface T₂ of the template T, and the inspection unit 32 may further inspect the rear surface T₂ of the template T.

In the wafer carry-in/out station 5, a cassette mounting table 50 is provided. The cassette mounting table 50 is configured such that a plurality of wafer cassettes C_{W} can be mounted thereon in a line in the X-direction (the top and bottom direction in FIG. 1). In other words, the wafer carry-in/out station 5 is configured to be capable of keeping a plurality of wafers W therein.

In the wafer carry-in/out station 5, a wafer carrying body 52 is provided which is movable on a carry path 51 extending in the X-direction. The wafer carrying body 52 is also movable in the vertical direction and around the vertical (in the O-direction), and thus can carry the wafer W between the wafer cassette C_{W} and the imprint unit 4.

In the wafer carry-in/out station 5, an alignment unit 53 adjusting the orientation of the wafer W is further provided. In the alignment unit 53, the orientation of the wafer W is adjusted based on, for example, the position of a notch portion of the wafer W. Further, a reversing unit 54 reversing the front and rear surfaces of the wafer W is provided in the wafer carry-in/out station 5.

Next, the configuration of the aforementioned imprint unit 4 will be described. The imprint unit 4 has a casing 55 having a carry-in/out port E1 for the template T and a carry-in/out port E2 for the wafer W which are formed in its side surfaces as illustrated in FIG. 5.

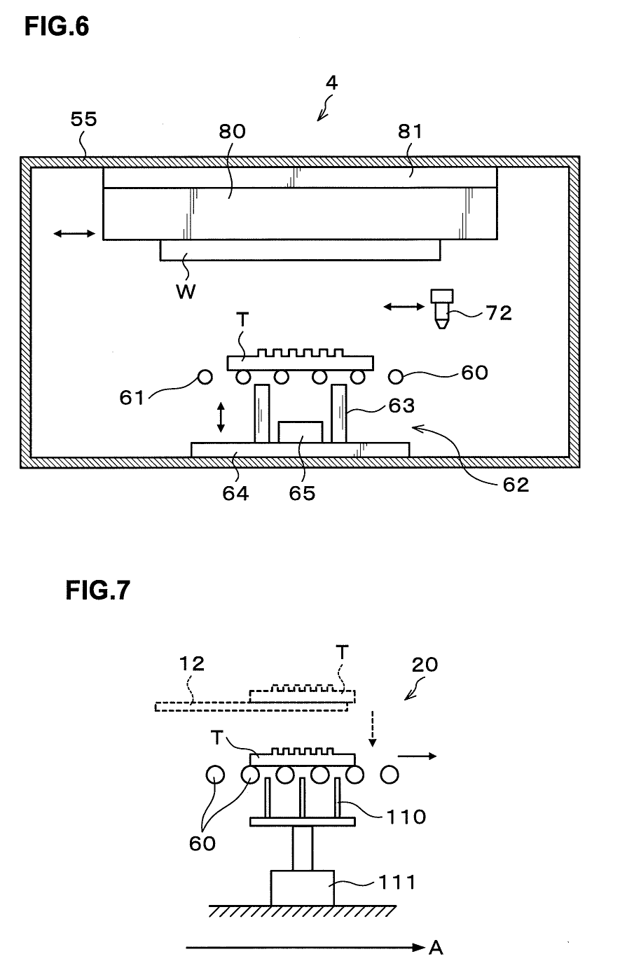

In the casing 55, a plurality of rollers 60, 61 are arranged as illustrated in FIG. 5 and FIG. 6. The carry rollers 60 are arranged next to each other, for example, in an almost L-shape so as to carry the template T passed through the carry line A1 and carried from the carry-in/out port E1, to a position above a later-described template holding part 62. The carry rollers 61 are arranged next to each other, for example, in an almost L-shape so to carry the template carried into the casing 55 out from the carry-in/out port E1 to the template carry-in/out station 2 through the carry line A2. Accordingly, the carry rollers 60, 61 are arranged to form an almost U-shape in the imprint unit and can carry the template T carried out of the template carry-in/out station 2, between the treatment station 3 and the imprint unit 4, and carry the template T again to the template carry-in/out station 2.

The template T is mounted on the carry rollers 60, 61 such that the front surface T₁ faces upward, namely, the rear surface T₂ is supported on the upper surfaces of the carry rollers 60, 61. Each of the carry rollers 60, 61 is configured to be rotatable around its center axis as a rotation axis. Further, drive mechanisms (not illustrated) having, for example, motors or the like built therein are provided at predetermined intervals so that at least one of the carry rollers 60, 61 among the plurality of carry rollers 60, 61 in contact with the template T can carry the template T. On both end sides of the center axis of the carry roller 60, 61, for example, carry guides (not illustrated) supporting the side surfaces of the template T are provided to prevent the template T from tumbling down from the almost U-shape portion when the template T is carried on the carry rollers 60, 61 arranged in the almost U-shape.

On the bottom surface in the casing 55, a template holding part 62 supporting the lower surface of the template T is provided as illustrated in FIG. 6. The template holding part 62 has a chuck 63 suction-holding a predetermined position of the rear surface T₂ of the template T. The chuck 63 is movable in the vertical direction by means of a moving mechanism 64 provided below the chuck.

The template holding part 62 has a light source 65 provided below the template T held by the chuck 63. From the light source 65, for example, light such as visible light, near ultraviolet light, ultraviolet light is emitted. The carry roller 60 corresponding to above the light source 65 has a shape that it is cut out at a position corresponding to above the light source 65 so as not to block the light from the light source 65 as illustrated in FIG. 5, so that the light from the light source 65 is transmitted through the template T and applied upward.

As illustrated in FIG. 5, on an X-direction positive direction (an upward direction in FIG. 5) side in the casing 55, a rail 70 extending along a Y-direction (a right and left direction in FIG. 5) is formed. On the rail 70, for example, an arm 71 is attached.

On the arm 71, a resist solution nozzle 72 as a coating solution supply part supplying a resist solution as a coating solution onto the template T is supported. The resist solution nozzle 72 has an elongated shape along the X-direction having, for example, the size equal to or longer than the dimension of one side of the template T. For the resist solution nozzle 72, for example, an ink-jet type nozzle is used, and a plurality of supply ports (not illustrated) formed in a line along the longitudinal direction are formed at a lower portion of the resist solution nozzle 72. The resist solution nozzle 72 can precisely control the supply timing of the resist solution, the supply amount of the resist solution and so on.

The arm 71 is movable on the rail 70 by means of a nozzle drive part 73. Thus, the resist solution nozzle 72 can move from a waiting section 74 provided at a Y-direction positive direction side outer position in the casing 55 to a position above the template T on the carry rollers 60, 61 and further move in the Y-direction above the front surface of the template T. Further, the arm 71 is movable up and down by means of the nozzle drive part 73 to be able to adjust the height of the resist solution nozzle 72.

On the ceiling surface in the casing 55 and above the carry rollers 60, 61, a wafer holding part 80 is provided as illustrated in FIG. 6. The wafer holding part 80 suction-holds the rear surface of the wafer W such that the surface to be treated of the wafer W faces upward. More specifically, the wafer holding part 80 and the carry rollers 60 are arranged such that the wafer W held by the wafer holding part 80 faces the template T mounted on the carry rollers 60. The wafer holding part 80 is movable in the horizontal direction by means of a moving mechanism 81 provide above the wafer holding part 80.

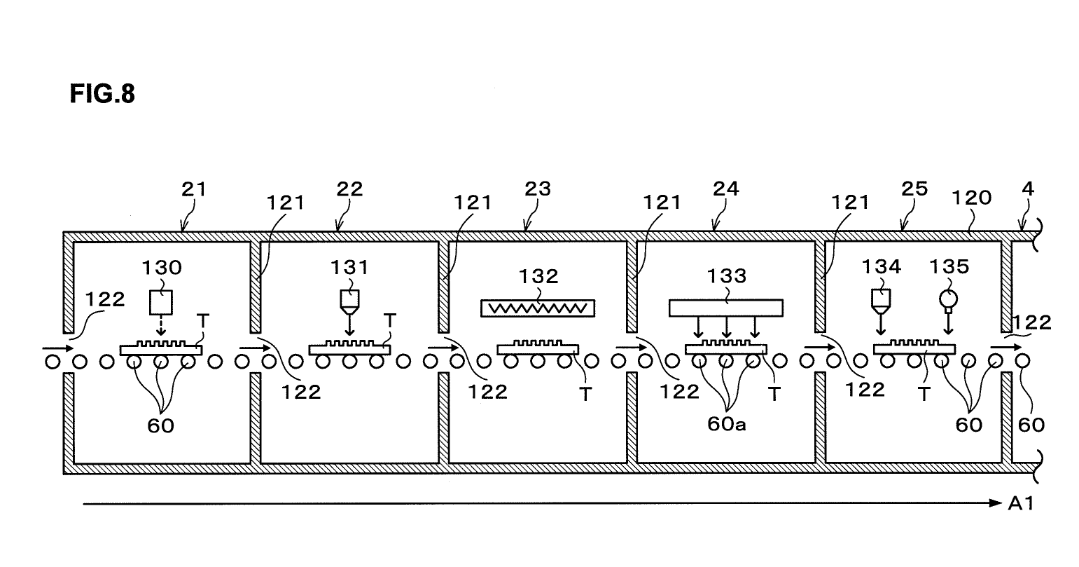

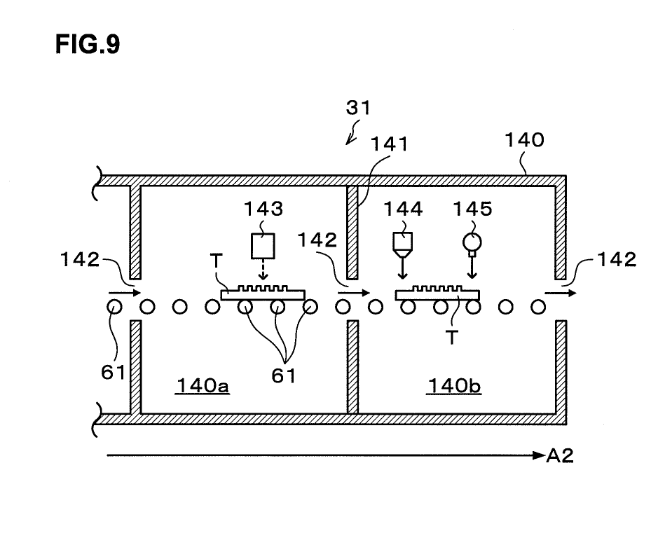

Next, the carry of the template T on the above-described carry lines A1, A2 will be described. Also on the carry line A1, the above-described plurality of carry rollers 60 are arranged next to each other along the carry line A1 through the casing of the imprint unit 4 as illustrated in FIG. 7 and FIG. 8. Similarly on the carry line A2, the plurality of carry rollers 61 are successively arranged next to each other along the carry line A2 through the casing of the imprint unit 4 as illustrated in FIG. 9. Each of the carry rollers 60, 61 is configured to be rotatable around its center axis extending at a right angle to the direction along the carry line A1, A2. Thus, the template T is carried on the carry rollers 60, 61 between the transition unit 20, 33 and the imprint unit 4.

Next, the configuration of the aforementioned transition unit 20 on the carry line A1 will be described. The transition unit 20 on the carry line A1 has raising and lowering pins 110 for supporting the template T from below and raising and lowering the template T as illustrated in FIG. 7. The raising and lowering pins 110 can move up and down by means of a raising and lowering drive part 111 provided below the carry rollers 60. Further, the raising and lowering pins 110 are arranged to be inserted between the plurality of carry rollers 60 arranged next to each other along the carry line A1. The template T is mounted on the carry rollers 60 from the template carrying body 12 by the raising and lowering pins 110.

Note that the configuration of the transition unit 33 on the carry line A2 is the same as that of the above-described transition unit 20, and therefore the description thereof will be omitted.

Next, the configurations of the aforementioned treatment units 21 to 25 on the carry line A1 will be described. On the carry line A1, a casing 120 is provided as illustrated in FIG. 8. The inside of the casing 120 is partitioned by a plurality of partition walls 121, and the partitioned spaces constitute the treatment units 21 to 25 respectively. In side surfaces of the partition walls 121 on the transition unit 20 side and on the imprint unit 4 side of the casing 120, carry-in/out ports 122 are formed respectively at the height corresponding to the carry rollers 60. Note that opening/closing shutters (not illustrated) are provided at the carry-in/out ports 122 to be able to hermetically close the insides of the treatment units 21 to 25.

The pre-cleaning unit 21 has an ultraviolet irradiation part 130 irradiating the template T with ultraviolet light. The ultraviolet irradiation part 130 is disposed above the carry rollers 60 and extends in the width direction of the template T (the longitudinal direction of the carry roller 60). The ultraviolet irradiation part 130 irradiates the front surface T₁ of the template T during carry on the carry rollers 60 with ultraviolet light, whereby the entire front surface T₁ of the template T is irradiated with the ultraviolet light. Note that “during carry of the template T” also includes the case that the template T is temporarily stopped on the carry rollers 60.

The release agent coating unit 22 includes a release agent nozzle 131 supplying a release agent onto the template T. The release agent nozzle 131 is disposed above the carry rollers 60. Further, the release agent nozzle 131 extends in the width direction of the template T and has a supply port (not illustrated) in a slit shape formed in its lower surface. The release agent nozzle 131 supplies the release agent onto the front surface T₁ of the template T during moving on the carry rollers 60, whereby the release agent is applied over the entire front surface T₁. To the release agent coating unit 22, a drain pipe (not illustrated) recovering and draining the release agent dropping from the template T and an exhaust pipe (not illustrated) exhausting the atmosphere in the release agent coating unit 22 are connected. Note that as the material of the release agent, a material having liquid repellency to a later-described resist film on the wafer W, for example, a fluorocarbon resin or the like is used.

The heating unit 23 has a heating plate 132 disposed above the carry rollers 60. Inside the heating plate 132, a heater generating heat, for example, by power feeding is provided to be able to regulate the heating plate 132 to a predetermined set temperature. Note that the heating plate 132 extends in the width direction of the template T and can heat the template T during carry on the carry rollers 60 from the front surface T₁ side. Note that, to the heating unit 23, an exhaust pipe (not illustrated) exhausting the atmosphere in the heating unit 23 is connected. Further, the heating plate 132 heats the template T from the front surface T₁ side in the illustrated example, but may heat the template T from the rear surface T₂ side. More specifically, the heating plate may be disposed at the same height as the carry rollers 60 or disposed below the carry rollers 60. Further, both the heating plates may be disposed to heat the template T from both sides of the front surface T₁ and the rear surface T₂.

In the temperature regulation unit 24, part of the carry rollers 60 constitute temperature regulation rollers 60a. Inside the temperature regulation rollers 60a, a cooling water cooling the template T circulates. Further, a gas supply part 133 spraying, for example, gaseous gas such an inert gas of nitrogen or dry air downward is disposed above the carry rollers 60. The gas supply part 133 extends in the width direction of the template T to be able to spray the gaseous gas to the entire front surface T₁ of the template T during carry. By the temperature regulation rollers 60a and the gas supply part 133, the template T is regulated to a predetermined temperature. Note that to the temperature regulation unit 24, an exhaust pipe (not illustrated) exhausting the atmosphere in the temperature regulation unit 24 is connected.

The rinse unit 25 has a rinse solution nozzle 134 supplying an organic solvent as a rinse solution for the release agent onto the template T and a gas nozzle 135 spraying, for example, gaseous gas such an inert gas of nitrogen or dry air onto the template T. The rinse solution nozzle 134 and the gas nozzle 135 are arranged above the carry rollers 60 in this order from the temperature regulation unit 24 side. Further, each of the rinse solution nozzle 134 and the gas nozzle 135 extends in the width direction of the template T and has a supply port (not illustrated) in a slit shape formed in its lower surface. Further, the release agent on the template T during carry on the carry rollers 60 can be rinsed away by the rinse solution nozzle 134, and the rinsed front surface T₁ of the template T can be then dried by the gas nozzle 135. Note that to the rinse unit 25, a drain pipe (not illustrated) recovering and draining the organic solvent dropping from the template T and an exhaust pipe (not illustrated) exhausting the atmosphere in the rinse unit 25 are connected.

Next, the configuration of the aforementioned post-cleaning unit 31 on the carry line A2 will be described. In the post-cleaning unit 31, a casing 140 is provided as illustrated in FIG. 9. The inside of the casing 140 is partitioned by a partition wall 141 into two treatment spaces 140a, 140b. In the partition wall 141 and side surfaces on the imprint unit 4 side and on the inspection unit 32 side of the casing 140, carry-in/out ports 142 for the template T are formed respectively at the height corresponding to the carry rollers 61. Note that opening/closing shutters (not illustrated) are provided at the carry-in/out ports 142 to be able to hermetically close the inside of the post-cleaning unit 31.

Inside the treatment space 140a on the imprint unit 4 side of the post-cleaning unit 31, an ultraviolet irradiation part 143 irradiating the template T with ultraviolet light is provided. Further, in the treatment space 140b on the inspection unit 32 side, a cleaning solution nozzle 144 supplying a cleaning solution onto the template T and a gas nozzle 145 spraying, for example, gaseous gas such an inert gas of nitrogen or dry air onto the template T are provided in this order from the imprint unit 4 side. The ultraviolet irradiation part 143, the cleaning solution nozzle 144, and the gas nozzle 145 are arranged above the carry rollers 61. The ultraviolet irradiation part 143 extends in the width direction of the template T (the longitudinal direction of the carry roller 61). The cleaning solution nozzle 144 and the gas nozzle 145 also extend in the width direction of the template T and have supply ports (not illustrated) in a slit shape formed in their lower surfaces. The ultraviolet irradiation part 143 applies ultraviolet light onto the template T during carry on the carry rollers 61 and the cleaning solution nozzle 144 then supplies the cleaning solution onto the template T to thereby be able to clean the front surface T₁ of the template T. Further, the cleaned front surface T₁ of the template T can be then dried by the gaseous gas from the gas nozzle 145. To the post-cleaning unit 31, a drain pipe (not illustrated) recovering and draining the cleaning solution dropping from the template T and an exhaust pipe (not illustrated) exhausting the atmosphere in the post-cleaning unit 31 are connected. Note that, for example, organic solvent or pure water is used for the cleaning solution, and IPA (isopropyl alcohol), dibutyl ether, cyclohexane or the like is used as the organic solvent.

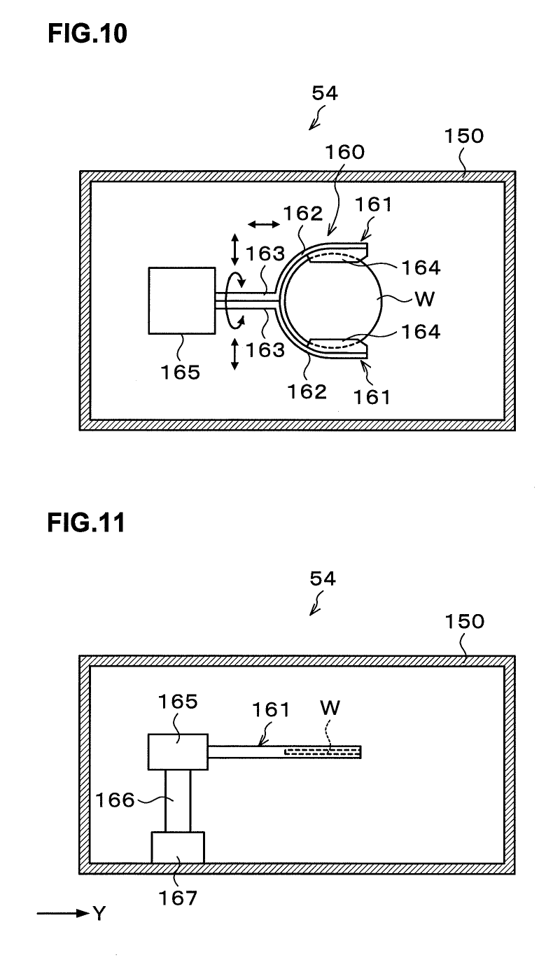

Next, the configuration of the aforementioned reversing unit 54 for the wafer W will be described. The reversing unit 54 has a casing 150 having a carry-in/out port (not illustrated) for the wafer W formed in its side surface as illustrated in FIG. 10.

In the casing 150, a reversing mechanism 160 reversing the front and rear surfaces of the wafer W is provided. The reversing mechanism 160 has a pair of holding parts 161, 161 capable of moving close to or away from each other. The holding parts 161 have frame parts 162 configured in an almost ¾ circular ring shape to conform to the outer diameter of the wafer W and arm parts 163 supporting the frame parts 162, and the frame part 162 and the arm part 163 are integrally formed. The frame part 162 is provided with a fastening part 164 for holding the wafer W, and a tapered groove (not illustrated) is formed at the fastening part 164. The pair of separated holding parts 161, 161 move close to each other, whereby the outer peripheral portion of the wafer W is inserted into the tapered grooves of the fastening parts 74 and the template T is thereby supported.

The holding parts 161 are supported by a rotation drive part 165 as illustrated in FIG. 11. By means of the rotation drive part 165, the holding parts 161 can rotate around the horizontal direction (around a Y-axis) to reverse the front and rear surfaces of the wafer W held by the holding parts 161. Further, the holding parts 161 can expand and contract in the horizontal direction (the Y-direction) by means of the rotation drive part 165 to carry the wafer W to the wafer carrying body 52. Below the rotation drive part 165, a raising and lowering drive part 167 is provided via a shaft 166. By means of the raising and lowering drive part 167, the rotation drive part 165 and the holding parts 161 can move up and down.

In the above imprint system 1, a control unit 200 is provided as illustrated in FIG. 1. The control unit 200 is, for example, a computer and has a program storage unit (not illustrated). In the program storage unit, a program is stored which controls the carry of the template T between the template carry-in/out station 2, the treatment station 3, and the imprint unit 4, the carry of the wafer W between the wafer carry-in/out station 5 and the imprint unit 4, the operation of the drive system in treatment station 3 and the imprint unit 4 and so on to thereby execute the later-described imprint processing in the imprint system 1. Note that this program may be the one that is stored, for example, in a computer-readable storage medium such as a computer-readable hard disk (I-ID), flexible disk (FD), compact disk (CD), magneto-optical disk (MO), or memory card, and installed from the storage medium into the control unit 200.

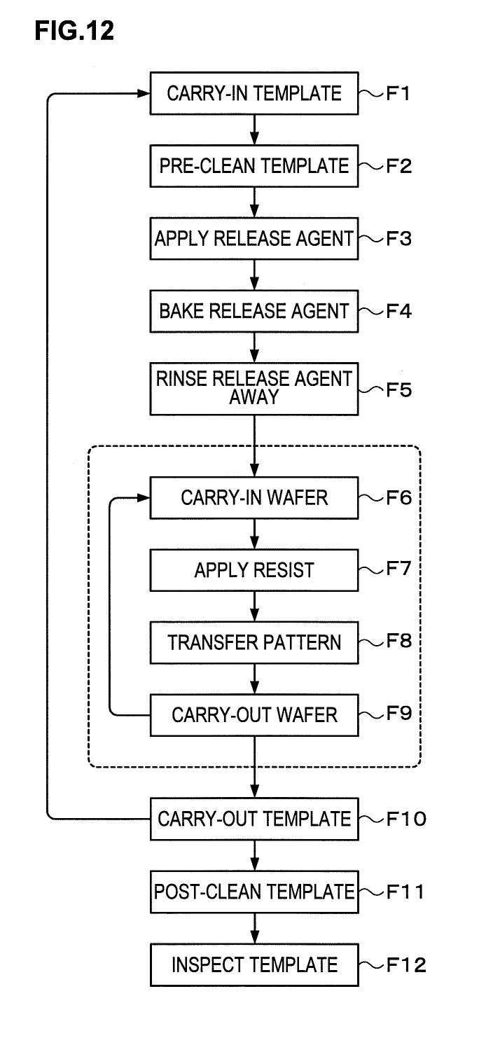

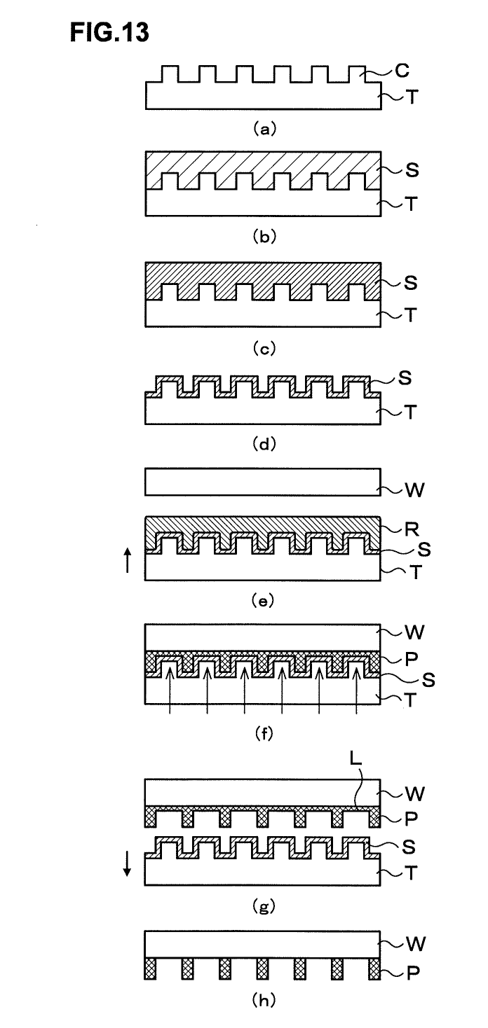

The imprint system 1 according to this embodiment is configured as described above. Next, the imprint processing performed in the imprint system 1 will be described. FIG. 12 illustrates a main processing flow of the imprint processing, and FIG. 13 illustrates the states of the template T and the wafer W in respective steps.

First of all, a template T is taken by the template carrying body 12 out of the template cassette C_{T} on the cassette mounting table 10 and carried to the transition unit 20 in the treatment station 3 (Step F1 in FIG. 12). In this event, the template T is housed in the template cassette C_{T} such that its front surface T₁ having the transfer pattern C formed thereon faces upward, so that the template T in this state is carried to the transition unit 20.

The template T carried into the transition unit 20 is mounted on the carry rollers 60 by the raising and lowering pin 110 and carried by roller carry along the carry line A1 at a predetermined speed. On the carry line A1, the template T is carried sequentially to the transition unit 20, the pre-cleaning unit 21, the release agent coating unit 22, the heating unit 23, the temperature regulation unit 24, and the rinse unit 25, and predetermined treatments are performed on the template T during carry in the treatment units 21 to 25.

More specifically, on the carry line A1, ultraviolet light is first applied from the ultraviolet irradiation part 130 onto the template T in the pre-cleaning unit 21, whereby the front surface T₁ of the template T is cleaned as illustrated in FIG. 13(a) (Step F2 in FIG. 12). Subsequently, the release agent S is supplied from the release agent nozzle 131 onto the template T in the release agent coating unit 22, whereby the release agent S is applied over the entire front surface T₁ of the template T as illustrated in FIG. 13(b) (Step F3 in FIG. 12). Thereafter, the template T is heated by the heating plate 132 to, for example, 200° C. in the heating unit 23, whereby the release agent S on the template T is baked as illustrated in FIG. 13(c) (Step F4 in FIG. 12). Thereafter, the template T is regulated to a predetermined temperature by the temperature regulation rollers 60a and the gas supply part 133 in the temperature regulation unit 24. Thereafter, the organic solvent is supplied from the rinse solution nozzle 134 to the template T in the rinse unit 25 to peel off only an unreacted portion of the release agent S on the template T. Thus, a film of the release agent S along the transfer pattern C is formed on the template T as illustrated in FIG. 13(d) (Step F5 in FIG. 12). Subsequently, the gaseous gas is sprayed from the gas nozzle 135 onto the template T in the rinse unit 25 to dry the front surface T₁, and the template T is then carried by the carry rollers 61 into the imprint unit 4. Note that the unreacted portion of the release agent S means a portion other than the portion of the release agent S chemically reacting with the front surface T₁ of the template T to adsorb onto the front surface T₁.

During the time when the predetermined treatments are performed on the template T in the treatment station 3 in this manner and the template T is carried to the imprint unit 4, a wafer W is taken by the wafer carrying body 52 out of the wafer cassette C_{W} on the cassette mounting table 50 and carried to the alignment unit 53 in the wafer carry-in/out station 5. Then, in the alignment unit 53, the orientation of the wafer W is adjusted based on the position of the notch portion of the wafer W. The wafer W is then reversed by the reversing unit 54 and carried to the imprint unit 4 (Step F6 in FIG. 12).

Then, after the template T is carried into the imprint unit 4, the resist nozzle 72 is moved in the Y-direction in FIG. 5 and supplies the resist solution onto the template T to form a resist film R as a coating film as illustrated in FIG. 13(e) (Step F7 in FIG. 12). In this event, the supply timing, the supply amount and so on of the resist solution supplied from the resist solution nozzle 72 are controlled by the control unit 200. More specifically, the control is conducted such that the amount of the resist solution to be applied to a portion formed in a protruding portion in the transfer pattern C of the template T (a portion corresponding to a recessed portion in the resist pattern to be formed on the wafer W) is small, while the amount of the resist solution to be applied to a portion corresponding to a recessed portion in the transfer pattern C (a portion corresponding to a protruding portion in the resist pattern) is large. The resist solution is applied onto the template T according to the aperture ratio of the transfer pattern C as described above to form the resist film R. Note that the resist solution is applied while the resist solution nozzle 72 is being moved in FIG. 5, but it is not always necessary to move the resist coating nozzle 72. This is because as long as the resist solution nozzle 72 is disposed, for example, above the carry rollers 60 and along the Y-direction near the carry-in/out port E1, it is possible to relatively move the template T with respect to the resist solution nozzle 72 to from the resist film R on the front surface T₁ of the template T even if the position of the resist solution nozzle 72 is fixed when carrying the template T in the X-direction positive direction (the upward direction in FIG. 5) by the carry rollers 60.

Upon formation of the resist film R on the template T, the wafer W held by the wafer holding part 80 is moved to a predetermined position in the horizontal direction to be aligned, and the lower surface of the template T is held by the chuck 63 of the template holding part 62. The template T held by the template holding part 62 is then rotated in a predetermined orientation. The template T is then moved up toward the wafer W as illustrated by an arrow in FIG. 13(e). The template T is moved up to a predetermined position, and the front surface T₁ of the template T is pressed against the resist film R on the wafer W. Note that the predetermined position is set based on the height of the resist pattern to be formed on the wafer W. Subsequently, light is applied from the light source 83. The light from the light source 83 is transmitted through the template T and applied to the resist film R on the wafer W as illustrated in FIG. 13(f), whereby photo polymerization of the resist film R takes place. In this manner, the transfer pattern C of the template T is transferred to the resist film R on the wafer W, whereby a resist pattern P is formed (Step F8 in FIG. 12).

Thereafter, the template T is moved down as illustrated in FIG. 13(g), whereby the resist pattern P is formed on the wafer W. In this event, since the release agent S has been applied on the front surface T₁ of the template T, the resist on the wafer W never adheres to the front surface T₁ of the template T. Thereafter, the wafer W is passed to the wafer carrying body 52, and carried from the imprint unit 4 to the wafer carry-in/out station 5 and returned to the wafer cassette C_{W} (Step F9 in FIG. 12). Note that though a thin residual film L of resist can remain in the recessed portion of the resist pattern P formed on the wafer W, the residual film L may be removed as illustrated in FIG. 13(h), for example, outside the imprint system 1.

By repeatedly performing the above-described Steps F6 to F9 (a part surrounded by a dotted line in FIG. 12), resist patterns P are formed respectively on a plurality of wafers W using one template T. During this time, the above-described Steps F1 to F5 are repeatedly performed to form films of the release agent S on the front surfaces T₁ of a plurality of templates T. The templates T on which the films of the release agent S have been formed are waiting on the carry rollers 60 on the carry line A1.

Then, after Steps F6 to F9 are performed on a predetermined number of wafers W, the used template T is carried from the carry rollers 60 to the carry rollers 61 and carried by the carry rollers 61 out of the imprint unit 4 to the carry line A2 (Step F10 in FIG. 12). Subsequently, a new template T is carried by the carry rollers 60 on the carry line A1 into the imprint unit 4. Thus, the template T in the imprint unit 4 is replaced. Note that the timing to replace the template T is set in consideration of the deterioration and the like of the template T. Further, also when a different pattern P is formed on the wafer W, the template T is replaced. The template T may be replaced, for example, every time the template T is used once. Alternatively, the template T may be replaced for every wafer W, or the template T may be replaced for every lot.

The used template T carried to the carry rollers 61 on the carry line A2 is carried by roller carry along the carry line A2 at a predetermined speed. On the carry line A2, the used template T is carried sequentially to the post-cleaning unit 31, the inspection unit 32, and the transition unit 33, and predetermined treatments are performed on the template T during carry in the treatment units 31, 32.

More specifically, on the carry line A2, the ultraviolet light is first applied onto the template T from the ultraviolet irradiation part 143 in the post-cleaning unit 31. Then, the release agent S on the template T vaporizes, and almost all of the release agent S is removed. Subsequently, the cleaning solution is supplied from the cleaning solution nozzle 144 to the release agent S remaining on the template T, and the gaseous gas is then sprayed from the gas nozzle 145 onto the template T, whereby the front surface T₁ is dried. In this manner, the release agent S on the template T is removed, whereby the front surface T₁ is cleaned (Step F11 in FIG. 12). Note that when pure water is used as the cleaning solution, it is preferable to further clean the front surface T₁ of the template T using IPA that is an organic solvent thereafter in order to prevent watermark from adhering to the front surface T₁. In the inspection unit 32, the front surface T₁ of the template T is then inspected, for example, by observation using interference fringes or the like (Step F12 in FIG. 12). Note that not only the front surface T₁ of the template T but also the rear surface T₂ may be cleaned in the post-cleaning unit 31. Further, not only the front surface T₁ of the template T but also the rear surface T₂ may be inspected in the inspection unit 32.

The template T carried to the transition unit 33 is passed by the raising and lowering pins 110 to the template carrying body 12 and returned to the template cassette C_{T}. Note that when the inspection result by the inspection unit 32 is good, for example, when the front surface T₁ of the template T has been appropriately cleaned and the front surface T₁ has not deteriorated, the template T returned to the template cassette C_{T} is used again in the imprint system 1. On the other hand, when the inspection result by the inspection unit 32 is bad, for example, when the front surface T₁ of the template T has deteriorated, the template T is carried to the outside of the imprint system 1.

In this manner, predetermined resist patterns P are successively formed on a plurality of wafers W while the template T is successively replaced in the imprint system 1.

The imprint system 1 in the above embodiment has the template carry-in/out station 2 and the wafer carry-in/out station 5 and the templates T can be successively carried by the carry rollers 60, 61, so that after predetermined patterns are formed on substrates using a template T in the imprint unit 4, the template T can be successively replaced with other templates T. Thus, for example, before the template T deteriorates or even when different patterns are formed on a plurality of wafers W, the template T in the imprint unit 4 can be successively and efficiently replaced. Accordingly, predetermined patterns can be successively formed on a plurality of wafers W. This also enables realization of mass production of semiconductor devices.

Further, since the predetermined treatments are performed on the template T during carry on a plurality of carry rollers 60, 61 on the carry line A1 and the carry line A2 in the treatment station 3, the predetermined treatments can be successively performed on the plurality of templates T.

Further, since the release agent forming section 26, namely, the treatment units 20 to 25 are provided in the treatment station 3, the templates T can be successively supplied into the imprint unit 4 while films of the release agent S are being formed on the templates T in the imprint system 1. Accordingly, the template in the imprint unit 4 can be more efficiently replaced.

Furthermore, since the template cleaning section 27, namely, the post-cleaning unit 31 is provided in the treatment station 3, the front surface T₁ of the used template T can be cleaned in the imprint system 1. Thus, the template T can be used again in the imprint system 1.

Further, since the ultraviolet irradiation part 143 and the cleaning solution nozzle 144 are provided in the post-cleaning unit 31, the front surface T₁ of the template T can be cleaned both with the ultraviolet light applied from the ultraviolet irradiation part 143 and the cleaning solution supplied from the cleaning solution nozzle 144. In other words, since both dry cleaning and wet cleaning are performed on the template T, the front surface T₁ of the template T can be surely cleaned.

Moreover, since the inspection unit 32 is provided in the treatment station 3, the front surface T₁ of the template T after the cleaning can be inspected. Then, based on the inspection result, for example, whether to use the template T again in the imprint system 1 or to carry the template T to the outside of the imprint system 1 can be decided. This makes it possible to effectively use the template T and avoid the use of a defective template T in the imprint system 1, thus appropriately forming predetermined resist patterns P on a plurality of wafers W.

According to the above embodiment, since the resist solution is applied onto the template T, it is possible to rapidly and efficiently form the resist pattern P on the wafer W in the imprint unit 4. Specifically, this is because it is unnecessary to perform alignment of the template T since the resist solution is applied onto the template T, unlike the case when the resist solution is applied onto the wafer W in which case after the resist nozzle is aligned to a predetermined position in the horizontal direction of the wafer W and applies the resist solution, the position in the horizontal direction of the template T needs to be aligned to a position corresponding to the applied resist solution.

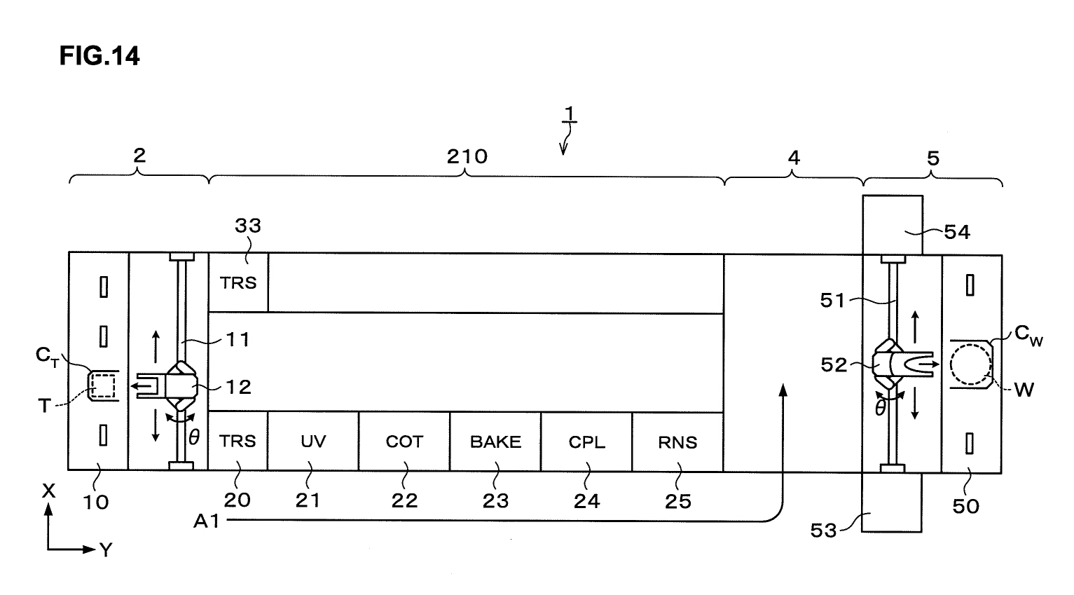

Though both the carry line A1 and the carry line A2 are provided in the treatment station 3 of the above embodiment, a treatment station 210 including only the carry line A1 may be provided and the treatment units 31, 32 on the carry line A2 may be omitted, for example, as illustrated in FIG. 14. Note that a plurality of carry rollers 61 are arranged at the positions of the omitted treatment units 31, 32 to perform only carry of the template T. In this case, Steps F11, F12 of the above embodiment are omitted and the cleaning of the front surface T₁ of the used template T is performed outside the imprint system 1.

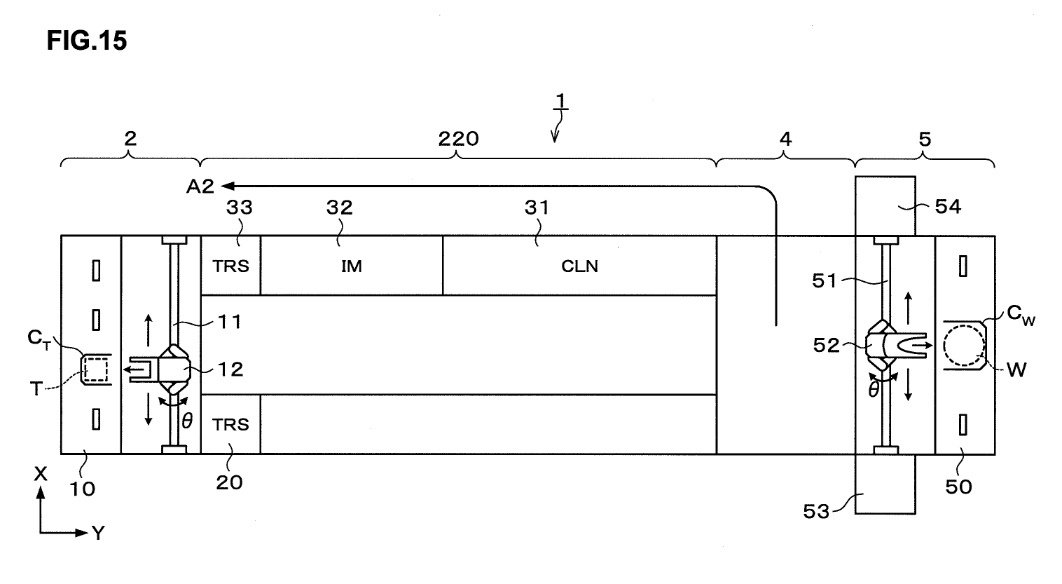

Further, a treatment station 220 including only the carry line A2 may be provided and the treatment units 21 to 25 on the carry line A1 may be omitted, for example, as illustrated in FIG. 15. Note that a plurality of carry rollers 60 are arranged at the positions of the omitted treatment units 21 to 25 to perform only carry of the template T. In this case, Steps F2 to F5 of the above embodiment are omitted and the film formation of the release agent S on the template T is performed outside the imprint system 1. In short, the template T on which a film of the release agent S has been formed is carried into the imprint system 1.

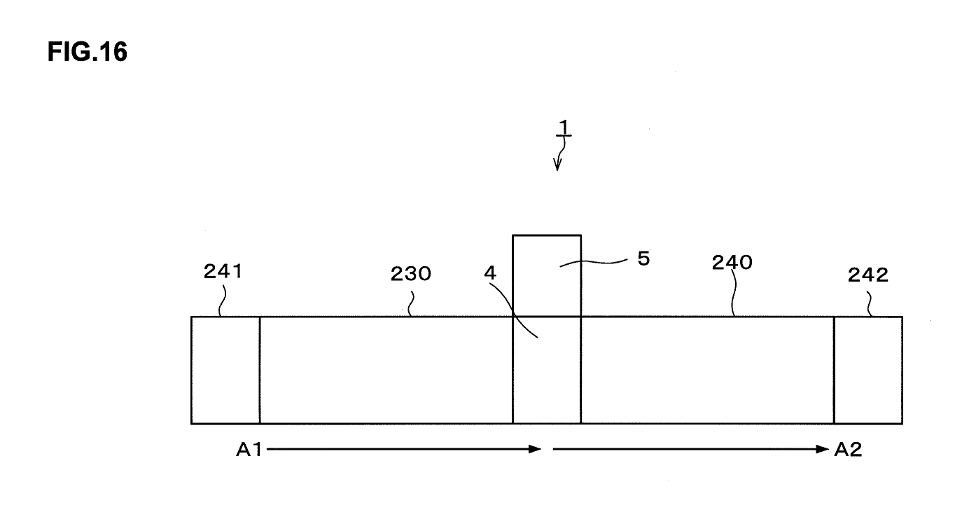

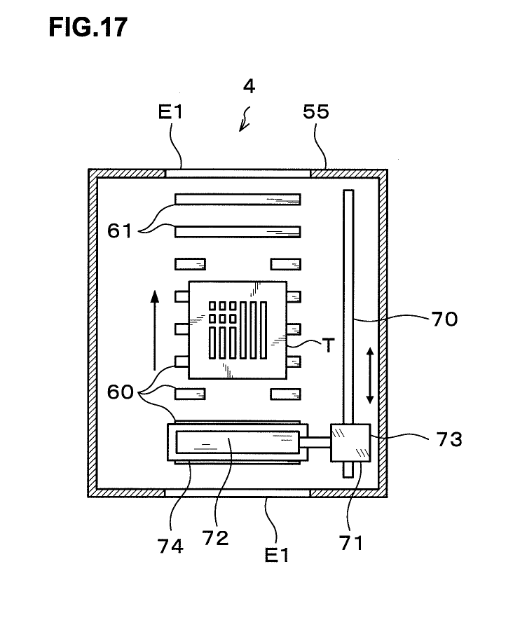

Further, for example, a treatment station 230 including only the carry line A1 and the carry rollers 60 and a treatment station 240 including only the carry line A2 and the carry rollers 61 may be linearly arranged in a line with the imprint unit 4 between them as illustrated in FIG. 16. In this case, to the side surface of the treatment station 230 opposite to the imprint unit 4 side, a template carry-out station 241 for carrying the template T out to the treatment station 230 is connected. Further, to the side surface of the treatment station 240 opposite to the imprint unit 4 side, a template carry-in station 242 into which the template T is carried from the treatment station 240 is connected. Furthermore, the template carry-out station 241 and the template carry-in station 242 may be arranged separate from each other, for example, as illustrated in FIG. 16. In this case, the carry rollers 60, 61 arranged in an almost L-shape respectively in the imprint unit 4 are linearly arranged in one line as illustrated in FIG. 17. Note that the treatment stations 230, 240 are linearly arrange with the imprint unit 4 between them in FIG. 16 but do not always need to be linearly arranged, and the treatment station 230 and the treatment station 240 may be arranged to intersect with each other.

In any case, the template T in the imprint unit 4 can be successively replaced, and predetermined patterns P can be successively formed on a plurality of wafers W.

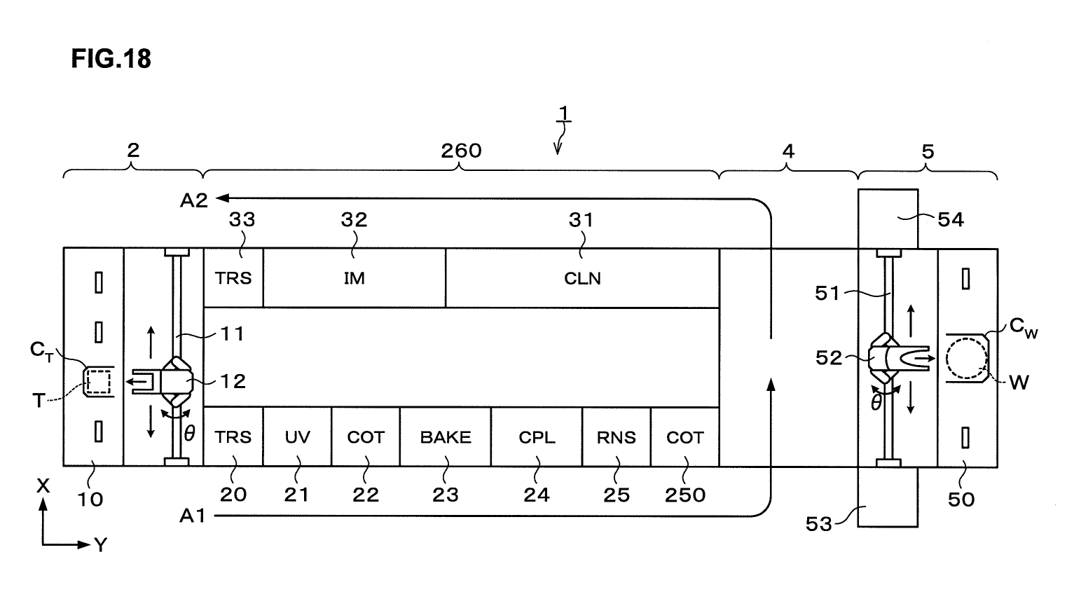

Further, the operation of applying the resist solution onto the template T performed in the imprint unit 4 in the above embodiment may be performed in a treatment station. In this case, a treatment station 260 is used in which a resist coating unit 250 as a coating unit applying the resist solution onto the template T is disposed between the imprint unit 4 and the rinse unit 25 on the carry line A1, for example, as illustrated in FIG. 18. The resist coating unit 250 has a configuration in which the release agent nozzle 131 in the release agent coating unit 22 illustrated in FIG. 8 is replaced with a resist solution nozzle supplying the resist solution. Note that in this case, it becomes unnecessary to apply the resist solution onto the template T in the imprint unit 4, so that the resist solution nozzle 72 in the imprint unit 4 can be omitted.

In this case, the template T on which the resist film R has been formed is carried into the imprint unit 4, so that after the resist pattern P is formed on one wafer W, the used template T is replaced. This reduces the number of treatment steps in the imprint unit 4, thus making it possible to rapidly form the resist pattern P on the wafer W.

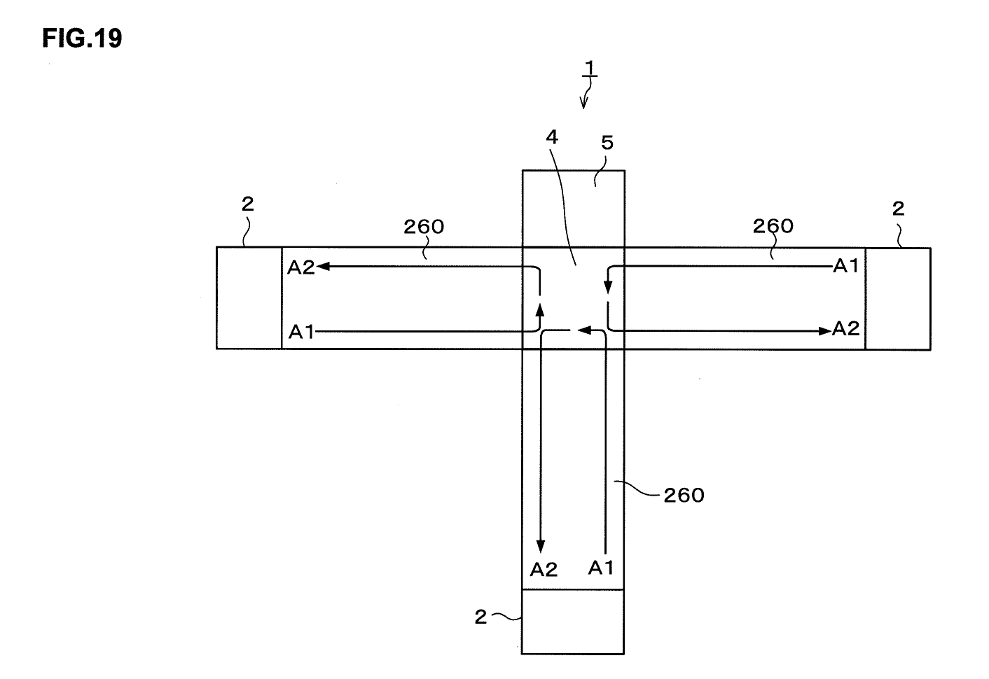

Further, in the case of using the treatment station 260, a plurality of, for example, three treatment stations 260 may be provided radially with respect to the imprint unit 4 as illustrated in FIG. 19. In this case, the carry rollers 61 are arranged to form three U shapes for the respective treatment stations 260 to cope with the three treatment stations 260 in the imprint unit 4.

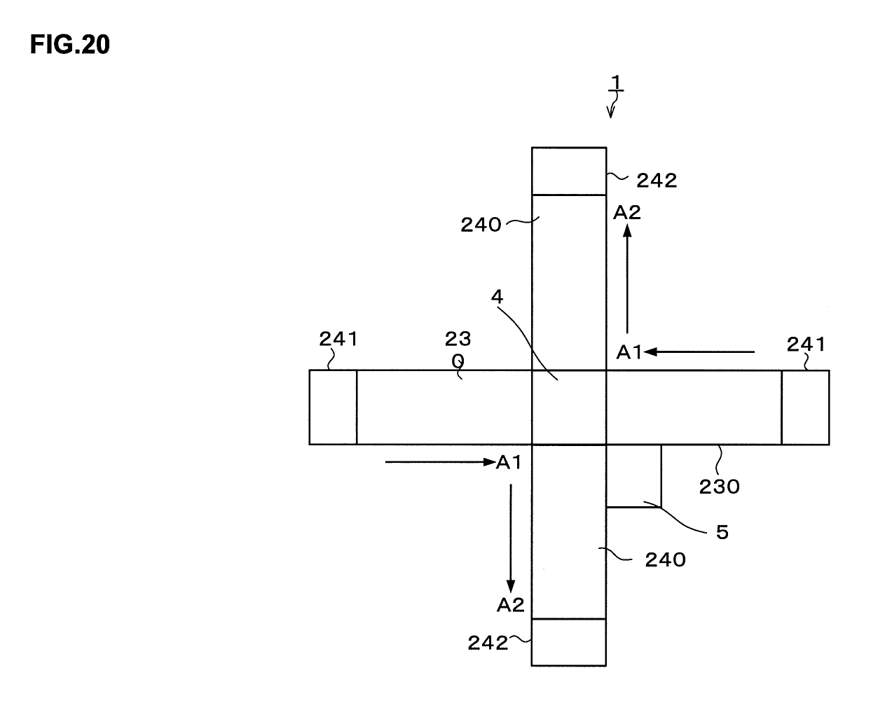

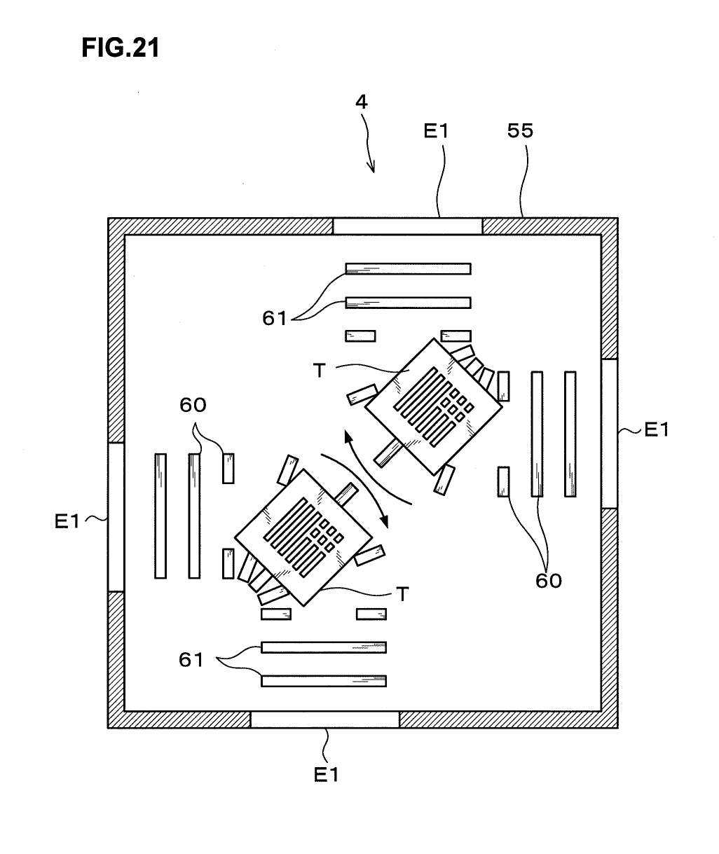

Further, a coating unit 250 may be provided in the treatment station 230, and a plurality of treatment stations 230, 240 may be radially connected to the imprint unit 4, for example, as illustrated in FIG. 20. In this case, the carry rollers 60, 61 arranged in the imprint unit 4 are arranged in almost L-shapes, for example, as illustrated in FIG. 21 in order to prevent the carry rollers 60, 61 from interfering with each other due to the linear arrangement of the treatment stations 230, 240 performing a series of treatments.

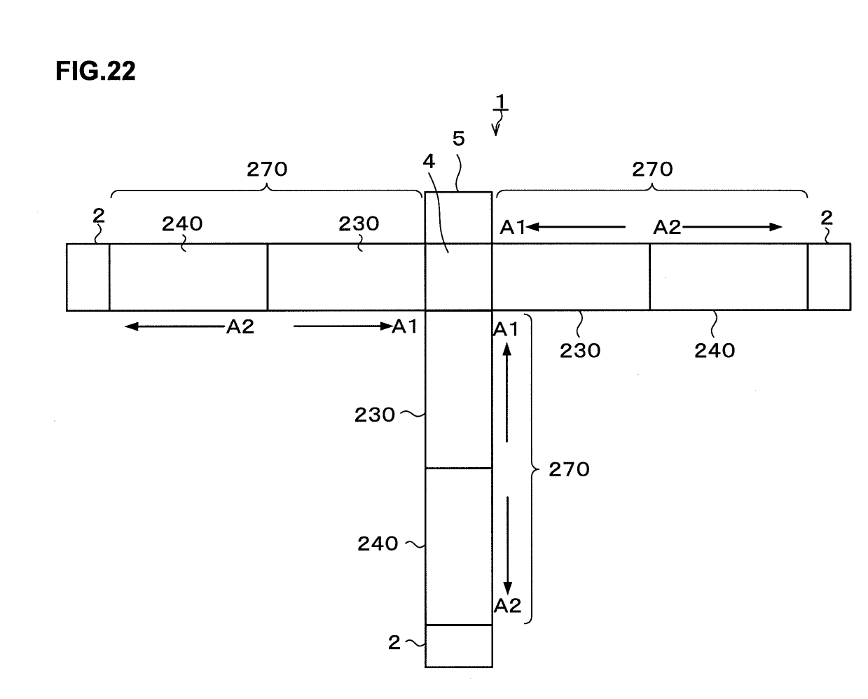

Moreover, treatment stations 270 in each of which the treatment station 230 including the coating unit 250 and the treatment station 240 are linearly arranged may be radially connected to the imprint unit 4 as illustrated in FIG. 22 so that the template T is reciprocally carried in the treatment stations 270 arranged in series. In this case, for example, only the carry rollers 60 are arranged in the imprint unit 4. As a moving mechanism rotating the carry rollers 60, 61, the one that is positively and negatively rotatable is used. When carrying the template T from the template carry-in/out station to the imprint unit 4, the moving mechanism is operated to positively rotate the carry rollers 60 and negatively rotate the carry rollers 61. Further, FIG. 22 illustrates the state that the imprint unit 4 and the treatment stations 230 are connected, but the arrangement of the treatment stations 230, 240 may be inverted in the treatment stations 270.

Note that the arrangement of the plurality of treatment stations provided for the imprint unit 4 is not limited to the radial shape, but the treatment stations may be connected to the imprint unit 4 from any direction as long as the template T can be carried to/from the imprint unit 4.

In any of the cases illustrated in FIG. 19, FIG. 20 and FIG. 22, the template T in the imprint unit 4 can be successively replaced and predetermined resist patterns P can be more efficiently formed on a plurality of wafers W. Note that in any case, the wafer W held by the wafer holding part 80 is moved to a predetermined position in the horizontal direction to be aligned and then the front surface T₁ of the template T is pressed against the resist film R on the wafer W.

Though both the ultraviolet irradiation part 143 and the cleaning solution nozzle 144 are provided in the post-cleaning unit 31 of the above embodiment, only one of them may be provided. For example, when the front surface T₁ of the template T is cleaned only by application of the ultraviolet light, only the ultraviolet irradiation part 143 may be provided and the cleaning solution nozzle 144 may be omitted in the post-cleaning unit 31 illustrated in FIG. 9. On the other hand, when the front surface T₁ of the template T is cleaned only by supply of the cleaning solution, only the cleaning solution nozzle 144 may be provided and the ultraviolet irradiation part 143 may be omitted in the post-cleaning unit 31 illustrated in FIG. 9. In this case, an organic solvent is used as the cleaning solution. Note that, for example, when IPA is used as the organic solvent, the release agent S can be removed only with the IPA. On the other hand, for example, when dibutyl ether or cyclohexane is used, it is preferable to further supply IPA after supply of the organic solvent, to remove the release agent S.

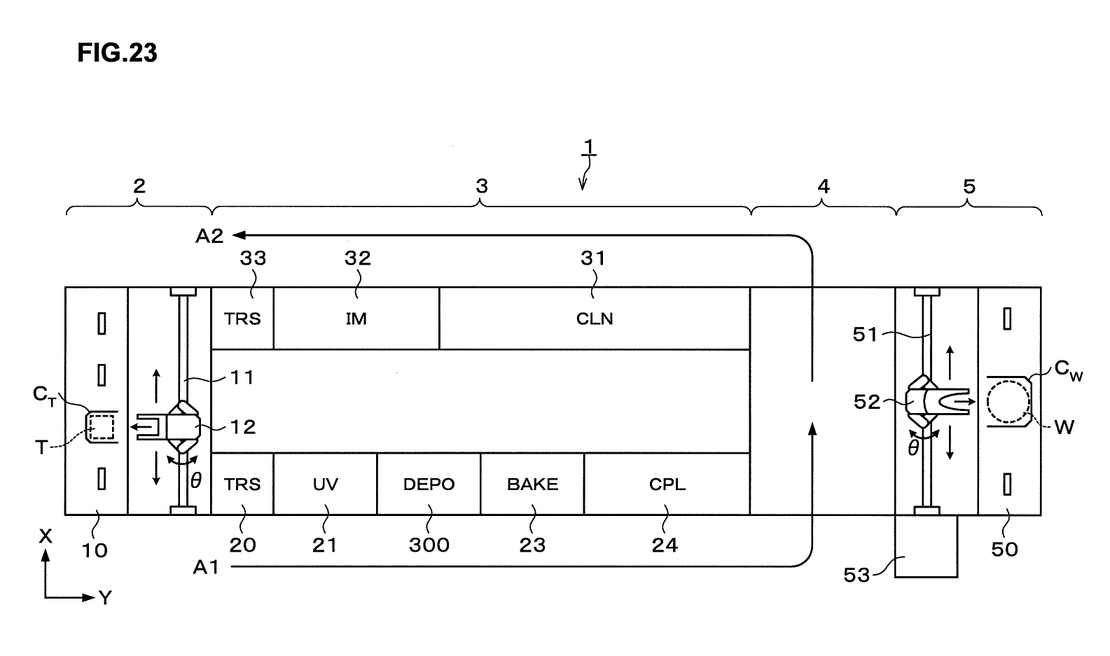

Though the release agent S is applied to the front surface T₁ of the template T by supplying the liquid release agent S from the release agent nozzle 131 onto the template T in the release agent coating unit 22 of the treatment station 3 in the above embodiment, a film of the release agent S may be formed by depositing a vaporized release agent on the front surface T₁ of the template T. In this case, a release agent coating unit 300 is arranged on the carry line A1 of the imprint system 1 as illustrated in FIG. 23 in place of the release agent coating unit 22 and the rinse unit 25 illustrated in FIG. 1. More specifically, in this case, the transition unit 20, the pre-cleaning unit 21, the release agent coating unit 300, the heating unit 23, and the temperature regulation unit 24 are arranged in a line in order from the template carry-in/out station 2 side to the imprint unit 4 side on the carry line A1.

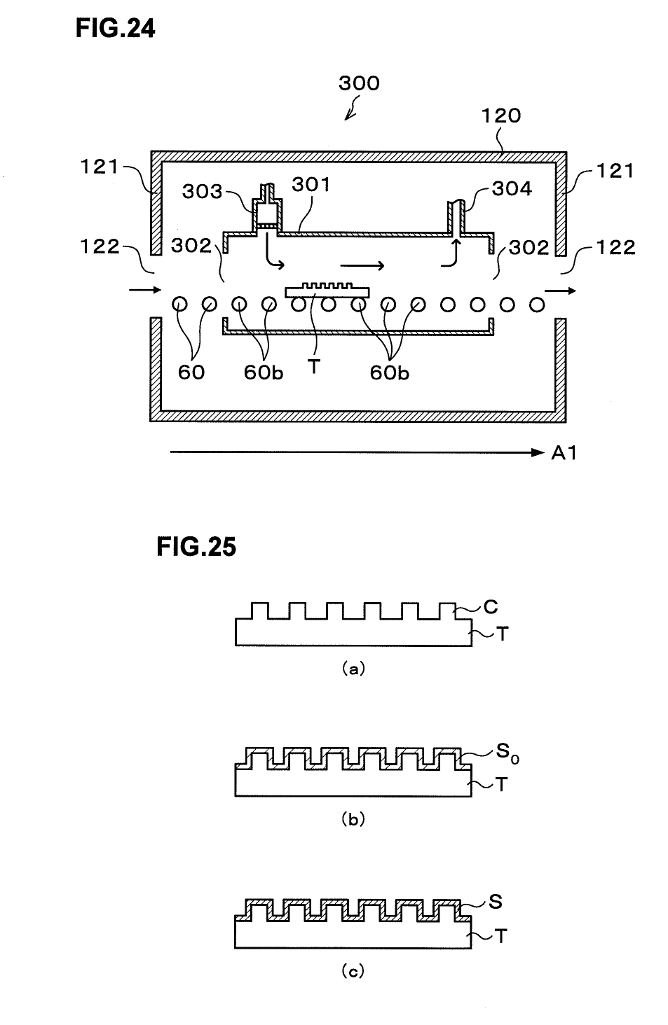

The release agent coating unit 300 has a casing 301 therein as illustrated in FIG. 24. In the side surfaces on the pre-cleaning unit 21 side and the heating unit 23 side of the casing 301, carry-in/out ports 302 for the template T are formed respectively at the height corresponding to the carry rollers 60. Note that opening/closing shutters (not illustrated) may be provided at the carry-in/out ports 302 to be able to hermetically close the inside of the casing 301.

To the casing 301, a release agent nozzle 303 supplying a vaporized release agent onto the template T and an exhaust pipe 304 exhausting the atmosphere in the casing 301 are connected. The release agent nozzle 303 and the exhaust pipe 304 are provided in this order from the pre-cleaning unit 21 side. Then, the vaporized release agent supplied from the release agent nozzle 303 flows in the direction of carry of the template T along the carry line A1 and is deposited along the transfer pattern C on the front surface T₁ of the template T.

The carry rollers 60 inside the casing 301 constitute temperature control rollers 60b. Inside the temperature control rollers 60b, a temperature regulating water at a predetermined temperature circulates. By the temperature control rollers 60b, the template T can be set to a predetermined temperature.

Next, a method of forming a film of the release agent S on the template T in the treatment station 3 in which the release agent coating unit 300 is arranged will be described.

In the treatment station 3, the template T is first carried to the pre-cleaning unit 21, in which the front surface T₁ of the template T is cleaned as illustrated in FIG. 25(a). Thereafter, the template T is carried to the release agent coating unit 300, in which a vaporized release agent S₀ is supplied onto the front surface T₁ of the template T as illustrated in FIG. 25(b) and the release agent S₀ is deposited along the transfer pattern C. In this event, the template T is set to a predetermined temperature by the temperature control rollers 60b. Thereafter, the template T is carried into the heating unit 23, in which the release agent S on the template T is baked as illustrate in FIG. 25(c). The template T is then carried to the temperature regulation unit 24, in which the template T is regulated to a predetermined temperature. In this manner, a film of the release agent S along the transfer pattern C is formed on the front surface T₁ of the template T.

According to the above embodiment, since the vaporized release agent S₀ is deposited along the transfer pattern C of the template T, it is unnecessary to rinse the release agent S away. Accordingly, it is possible to more smoothly form a film of the release agent S on the template T in the treatment station 3 and thereby improve the throughput of the imprint processing in the imprint system 1.

Note that after the vaporized release agent S₀ is supplied onto the front surface T₁ of the template T in the release agent coating unit 300, the release agent S₀ may be dried under reduced pressure. In this case, the carry of the template T in the release agent coating unit 300 may be temporarily stopped.

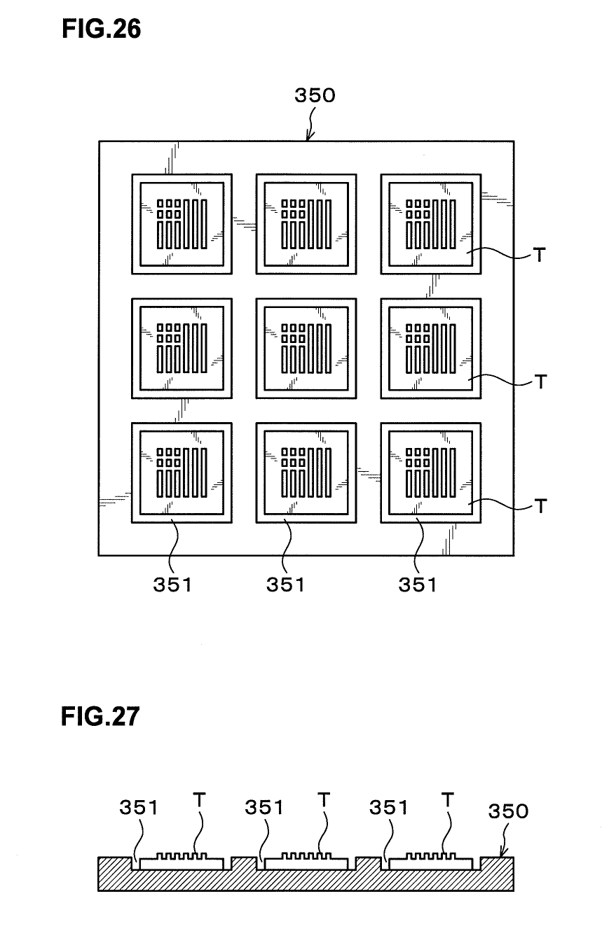

Though the template T is individually carried and treated in the template carry-in/out station 2 and the treatment station 3 in the above embodiment, a plurality of, for example, nine templates T may be held by one holder 350 and treated as illustrated in FIG. 26. In this case, accommodating parts 351 recessed downward for accommodating the templates T are formed in the holder 350 as illustrated in FIG. 27. At the bottom surfaces of the accommodating parts 351, for example, a plurality of suction ports (not illustrated) are formed to suction-hold the templates T in the accommodating parts 351.

According to this embodiment, a plurality of templates T held by the holder 350 can be carried at a time to the imprint unit 4 side. Further, it is possible to perform predetermined treatments on the plurality of templates T at a time in the treatment station 3. Therefore, it is possible to more efficiently replace the template T in the imprint unit 4. Moreover, when, for example, nine templates T having the same transfer pattern C are held by the one holder 350, a plurality of transfer patterns C can be transferred onto the wafer W at a time by the plurality of templates T in the imprint unit 4, so that the transfer of the transfer patterns C to the wafer W can be more efficiently performed.

Though the template holding part 62 is provided below the wafer holding part 80 in the imprint unit 4 in the above embodiment, a reversing unit reversing the template T carried by the carry rollers 60 may be provided, in place of the reversing unit 54 for the wafer W, outside or inside the imprint unit 4, the template holding part 62 may be disposed at the ceiling of the casing 55, and the wafer holding part 80 may be disposed at the bottom surface of the casing 55.

In this case, since the template T is smaller than the wafer W, the front and rear surfaces of the template T can be easily reversed.

Preferred embodiments of the present invention have been described above with reference to the accompanying drawings, but the present invention is not limited to the embodiments. It should be understood that various changes and modifications are readily apparent to those skilled in the art within the scope of the technical spirit as set forth in claims, and those should also be covered by the technical scope of the present invention. The present invention is not limited to the embodiments but can take various forms. The present invention is also applicable to the case where the substrate is a substrate other than the wafer, such as an FPD (Flat Panel Display), a mask reticle for a photomask or the like.

### INDUSTRIAL APPLICABILITY

The present invention is useful in transferring a transfer pattern to a coating film formed on a substrate using a template having the transfer pattern formed on a front surface thereof to form a predetermined pattern in the coating film.

### EXPLANATION OF CODES

1 imprint system
2 template carry-in/out station
3 treatment station
4 imprint unit
5 wafer carry-in/out station
10 cassette mounting table
11 carry path
12 template carrying body
21 pre-cleaning unit
22 release agent coating unit
23 heating unit
24 temperature regulation unit
25 rinse unit
26 release agent forming section
27 template cleaning section
31 post-cleaning unit
32 inspection unit
50 cassette mounting table
51 carry path
52 wafer carrying body
53 alignment unit
54 reversing unit
55 casing
60, 61 carry roller
60a temperature regulation roller
60b temperature control roller
62 template holding part
63 chuck
70 rail
71 arm
72 resist solution nozzle
73 nozzle drive part
74 waiting section
80 wafer holding part
81 moving mechanism
110 raising and lowering pin
111 raising and lowering drive part
120 casing
121 partition wall
122 carry-in/out port
130 ultraviolet irradiation part
131 release agent nozzle
132 heating plate
133 gas supply part
134 rinse solution nozzle
135 gas nozzle
140 casing
141 partition plate
142 carry-in/out port
143 ultraviolet irradiation part
144 cleaning solution nozzle
145 gas nozzle
150 casing
160 reversing mechanism
161 holding part
162 frame part
163 arm part
164 fastening part
165 rotation drive part
166 shaft
167 raising and lowering drive part
200 control unit
210 treatment station
220 treatment station
230 treatment station
240 treatment station
241 template carry-out station
242 template carry-in station
250 resist coating unit
260 treatment station
270 treatment station
300 release agent coating unit
301 casing
302 carry-in/out port
303 release agent nozzle
304 exhaust pipe
350 holder
351 accommodating part
A, A1, A2 carry line
C transfer pattern
E1, E2 carry-in/out port
P resist pattern
R resist film
S release agent
T template
W wafer

What is claimed:

1. An imprint system forming a predetermined pattern in a coating film on a substrate, said imprint system comprising:
an imprint unit transferring a transfer pattern to the coating film on the substrate using a template having the transfer pattern formed on a front surface thereof to form a predetermined pattern in the coating film;
a treatment station connected to said imprint unit and performing a predetermined treatment on the template;
a template carry-in/out station connected to said treatment station, capable of keeping a plurality of the templates, and carrying the template in/out from/to said treatment station;
a carry line provided through said imprint unit and carrying the template between said imprint unit and said treatment station; and
a substrate carry-in/out station connected to said imprint unit, capable of keeping a plurality of the substrates, and carrying the substrate in/out from/to said imprint unit,
wherein said imprint unit comprises a substrate holding part holding the substrate, a template holding part holding a template carried by said carry line, and a moving mechanism raising and lowering said template holding part, and said substrate holding part and said template holding part are arranged such that the substrate held by said substrate holding part and the template held by said template holding part face each other.

2. The imprint system as set forth in claim 1,
wherein said carry line comprises a first carry line carrying the template to said imprint unit, and a second carry line carrying a template carried from said imprint unit.

3. The imprint system set forth in claim 2,
wherein said template carry-in/out station comprises a template carry-out station carrying a template out to said treatment station and a template carry-in station carrying a template in from said treatment station,
wherein said carry-out station and said carry-in station are separately arranged, and
wherein said first carry line is connected to said template carry-in station, and said second carry line is connected to said template carry-out station.

4. The imprint system as set forth in claim 1,
wherein a plurality of said carry lines are provided for said one imprint unit.

5. The imprint system as set forth in claim 4,
wherein said plurality of carry lines are radially connected to said imprint unit.

6. The imprint system as set forth in claim 1,
wherein said treatment station comprises a release agent forming part forming a film of a release agent on the template.

7. The imprint system as set forth in claim 1,
wherein said treatment station comprises a template cleaning part removing a release agent on a template carried out of said imprint unit to clean the front surface of the template.

8. The imprint system as set forth in claim 1,
wherein said treatment station performs a predetermined treatment on the template during carry on said carry line.

9. The imprint system as set forth in claim 1,
wherein a plurality of the templates are held by one holder at least in said treatment station and said imprint unit.

10. An imprint method using an imprint system, the imprint system comprising:
an imprint unit transferring a transfer pattern to a coating film on a substrate using a template having the transfer pattern formed on a front surface thereof to form a predetermined pattern in the coating film;
a treatment station connected to the imprint unit and performing a predetermined treatment on the template;
a template carry-in/out station connected to the treatment station, capable of keeping a plurality of the templates, and carrying the template in/out from/to the treatment station;
a carry line provided throughout the imprint unit and the treatment station, and carrying the template between the imprint unit and the treatment station; and
a substrate carry-in/out station connected to the imprint unit, capable of keeping a plurality of the substrates, and carrying the substrate in/out from/to the imprint unit,
said imprint method comprising the steps of:
forming a predetermined pattern on a substrate using one of the templates in the imprint unit; and
then carrying the one template out of the imprint unit and carrying another of the templates into the imprint unit and replacing the template in the imprint unit.

11. The imprint method as set forth in claim 10,
wherein a film of a release agent is formed on a template to be carried into the imprint unit, in the treatment station.

12. The imprint method as set forth in claim 10,
wherein a release agent on a template carried out of the imprint unit is removed to clean the front surface of the template, in the treatment station.

13. The imprint method as set forth in claim 10,
wherein a plurality of the templates are held by one holder at least in the treatment station and the imprint unit.

14. A non-transitory computer-readable storage medium storing a program running on a computer of a control unit controlling an imprint system to cause the imprint system to execute an imprint method,
the imprint method being an imprint method using the imprint system, the imprint system comprising: an imprint unit transferring a transfer pattern to a coating film on a substrate using a template having the transfer pattern formed on a front surface thereof to form a predetermined pattern in the coating film; a treatment station connected to the imprint unit and performing a predetermined treatment on the template; a template carry-in/out station connected to the treatment station, capable of keeping a plurality of the templates, and carrying the template in/out from/to the treatment station; a carry line provided throughout the imprint unit and the treatment station, and carrying the template between the imprint unit and the treatment station; and a substrate carry-in/out station connected to the imprint unit, capable of keeping a plurality of the substrates, and carrying the substrate in/out from/to the imprint unit,
the imprint method comprising the steps of:
forming a predetermined pattern on a substrate using one of the templates in the imprint unit; and
then carrying the one template out of the imprint unit and carrying another of the templates into the imprint unit and replacing the template in the imprint unit.
